(19) United States
(12) Patent Application Publication
(10) Pub. No.: US 2015/0138917 A1
(43) Pub. Date: May 21, 2015

(54) SEISMIC SURVEY SHOT COORDINATION APPARATUS METHOD AND SYSTEM

(71) Applicant: CGG Services SA, Massy (FR)

(72) Inventors: Jason Jurok, Corssfield (CA); Tom Preusser, Calgary (CA); Olivier Winter, Houston, TX (US); Peter Maxwell, Missouri City, TX (US)

(73) Assignee: CGG Services SA, Massy (FR)

(21) Appl. No.: 14/081,596

(22) Filed: Nov. 15, 2013

(51) Int. Cl. G01V 1/104

(52) U.S. Cl. CPC G01V 1/104
USPC 367/14

(57) ABSTRACT

A method for controlling impulsive sources during a geophysical survey includes receiving a set of predetermined shooting times for an impulsive source, receiving a detonation authorization for the impulsive source, and delaying a triggering of the impulsive source until a next available shooting time of the plurality of predetermined shooting times. A corresponding apparatus and system are also disclosed herein.

### BACKGROUND

1. Technical Field

Embodiments of the subject matter disclosed herein generally relate to the field of geophysical data acquisition and processing. In particular, the embodiments disclosed herein relate to apparatuses, methods, and systems for coordinating impulsive sources during a geophysical survey such as a seismic survey.

2. Discussion of the Background

Geophysical data is useful for a variety of applications such as weather and climate forecasting, environmental monitoring, agriculture, mining, and seismology. As the economic benefits of such data have been proven, and additional applications for geophysical data have been discovered and developed, the demand for localized, high-resolution, and cost-effective geophysical data has greatly increased. This trend is expected to continue.

For example, seismic data acquisition and processing may be used to generate a profile (image) of the geophysical structure under the ground (either on land or seabed). While this profile does not provide an exact location for oil and gas reservoirs, it suggests, to those trained in the field, the presence or absence of such reservoirs. Thus, providing a high-resolution image of the subsurface of the earth is important, for example, to those who need to determine where oil and gas reservoirs are located.

Traditionally, a land seismic survey system 10 capable of providing a high-resolution image of the subsurface of the earth is generally configured as illustrated in FIG. 1 (although many other configurations are used). System 10 includes plural receivers 12 and acquisition units 12a positioned over an area 13 of a subsurface to be explored and in contact with the surface 14 of the ground. A number of seismic sources 16 are also placed on surface 14 in an area 17, in a vicinity of area 13 of receivers 12. A recording device 18 is connected to a plurality of receivers 12 and placed, for example, in a station-truck 20. Each source 16 may be composed of a variable number of vibrators or explosive devices, and may include a local controller 22. A central controller 24 may be present to coordinate the shooting times of the sources 16. A positioning system 26 (e.g. GPS, GLONASS, Galileo, and Beidou) may be used to time-correlate sources 16 and receivers 12 and/or acquisition units 12a.

With this configuration, the sources 16 are controlled to generate seismic waves, and the receivers 12 record the waves reflected by the subsurface. The receivers 12 and acquisition units 12a may be connected to each other and the recording devices with cables 30. Alternately, the receivers 12 and acquisition units 12a can be paired as autonomous nodes that do not need the cables 30.

The purpose of seismic imaging is to generate high-resolution images of the subsurface from acoustic reflection measurements made by the receivers 12. Conventionally, as shown in FIG. 1, the plurality of seismic sources and receivers is distributed on the ground surface at a distance from each other. The sources 16 are activated to produce seismic waves that travel through the subsoil. These seismic waves undergo deviations as they propagate. They are refracted, reflected, and diffracted at the geological interfaces of the subsoil. Certain waves that have travelled through the subsoil are detected by the seismic receivers 12 and are recorded as a function of time in the form of signals (called traces).

Referring to FIG. 2, while continuing to refer to FIG. 1, the seismic sources 16 may be placed at a variety of source locations 40 and the receivers 12 may be placed at a variety of receiving locations 50. The source locations 40 and the receiving locations 50 may be selected to provide a sufficient number of traces to capture the features of the subsurface with high fidelity. In the survey scenario shown in FIG. 2, the source locations 40 and the receiving locations 50 are substantially orthogonal grids that are capable of generating a large number of traces.

In many surveys, the sources 16 and the receivers 12 are moved (i.e., “rolled”) from locations at a trailing edge of the survey area 13 to locations at a leading edge. Moving the sources and receivers in the described manner provides a high density grid of source locations 40 and recording locations 50 over a large area with a limited number of sources 16 and receivers 12.

A source location 40 may be activated by placing a selected source 16 at the source location 40 and “firing” the selected source 16. One of the sources 16 may be fired at each source location 40 at a distinct time in order to enable each active receiver 16 to collect a unique trace for each source location 40 that is activated while it resides at a particular recording location 50. In some scenarios, millions of traces are collected, and each trace corresponds to a subsurface midpoint (not shown) between a particular source location 40 and a particular recording location 50.

The sources 16 are generally divided into two categories: vibrating sources that vibrate the ground with a selected input waveform; and impulsive sources that deliver an impulse to the ground. FIG. 3 depicts a shot coordination system 300 wherein, similar to many seismic surveys, the sources 16 are impulsive sources. In the depicted system 300, the sources 16 are single-use devices that include an explosive charge 305 attached to corresponding detonator 310. The sources 16 may be buried below the surface at the source locations 40 (not shown in FIG. 3) and provided with connection leads 312 at the surface. Each source 16 may have a unique identification code for tracking purposes.

Subsequent to placement of a particular source 16, a technician known as a shooter 320 electrically connects a shot controller 330 to a selected detonator 310s by connecting a set of wire leads 332 for the shot controller to the connection leads 312 at a detonator connection location 334. The wire leads 332 are of sufficient length to enable the shooter to retreat to a shot control location 340 that is a safe distance from the explosive charge of the selected detonator 310s. At a selected point in time, the shooter 320, while remaining at the shot control location 340, activates the shot controller 330. In response thereto, the activated shot control 330 sends a signal, such as a high voltage pulse, over the wire leads and thereby detonates a selected explosive charge 305s via the selected detonator 310s.

In order to activate the sources 16 at each source location 40 in a reasonable amount of time, a relatively large number of shooters 320 may be concurrently deployed over the survey area 13. Each shooter may receive authorization to activate a source from an observer/coordinator 390 via radio communications. In some environments, radio communications may be difficult and miscommunications may occur.

As the shooters execute their shots at the intended locations the shot controllers 330 may communicate with a recording unit 380 which records the actual shooting times for each shot location 40. The information recorded by the recording unit 380 may conform to the Shell Processing Support (SPS) positioning data format.

The reader may appreciate that coordinating the movement of the shooters 320 and the firing of the sources 16 at a large number of source locations 40 may be a tedious, time consuming, and error prone process. In the case of sources 16 with explosive charges 305, it is a process that is also potentially very dangerous. Furthermore, with explosive charges the seismic data must be analyzed to detect overlapping shots. If the shots overlap, retaking the shots may require re-drilling of the source locations, and freezing or repositioning the rolling spread to the correct formation. The delays and costs associated with such activities are typically prohibitive.

Furthermore, as the density of shot locations (which are currently as little as 5 meters apart) continues to increase in order to provide higher resolution seismic data, field crews are experiencing a number of issues with the shot coordination system 300. For example, initiating shots with the system 300 is slow and cumbersome in that the shooter must repeatedly advance to the source 16 to connect the shot controller 330 to the source 16, retreat a safe distance to take the shot, and then re-approach the source 16 to disconnect the shot controller 330 from the source 16. In addition to issues with advancing and retreating, determining the actual location of the impulsive source at the time of shooting is problematic in that the shooter (and therefore the positioning device of the shot controller 330) must typically be positioned at least 30 meters away from the source 16 for safety reasons.

Due to the foregoing, there is a need for flexible shot coordination methods, apparatuses, and systems that can be applied to impulsive devices. Furthermore, there is a need for flexible shot coordination methods, apparatuses, and systems that do not require repeatedly advancing toward, and retreating from, the sources 16.

### SUMMARY

As detailed herein, a method for controlling impulsive sources during a geophysical survey includes receiving a set of predetermined shooting times for an impulsive source, receiving a detonation authorization for the impulsive source, and delaying a triggering of the impulsive source until a next available shooting time of the plurality of predetermined shooting times. A corresponding apparatus and system are also disclosed herein.

Another system for controlling impulsive sources during a geophysical survey is also disclosed herein. The system includes a triggering unit that interfaces to an impulsive source and provides an estimated current location for the impulsive source and a shot controller configured to transmit a detonation authorization to the triggering unit. The shot controller or the triggering unit may inhibit detonation of an impulsive source connected to the selected triggering unit if an estimated current location of the impulsive source is substantially different than an intended shot location. A corresponding apparatus and method are also disclosed herein.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram depicting a traditional land seismic survey system;

FIG. 2 is a source receiver location plot for a portion of a typical survey;

FIG. 3 is a block diagram of a traditional land survey shot coordination system;

FIG. 4a is a block diagram depicting one embodiment of a shot coordination apparatus;

FIG. 4b is a block diagram depicting one embodiment of a partitioned shot coordination apparatus;

FIG. 5 is a block diagram of a planned shot coordination system;

FIG. 6 is flowchart diagram depicting one embodiment of a shot coordination method;

FIG. 7 is a block diagram of an expedited shot coordination system; and

FIG. 8 is flowchart diagram depicting one embodiment of a shot coordination method for a field crew.

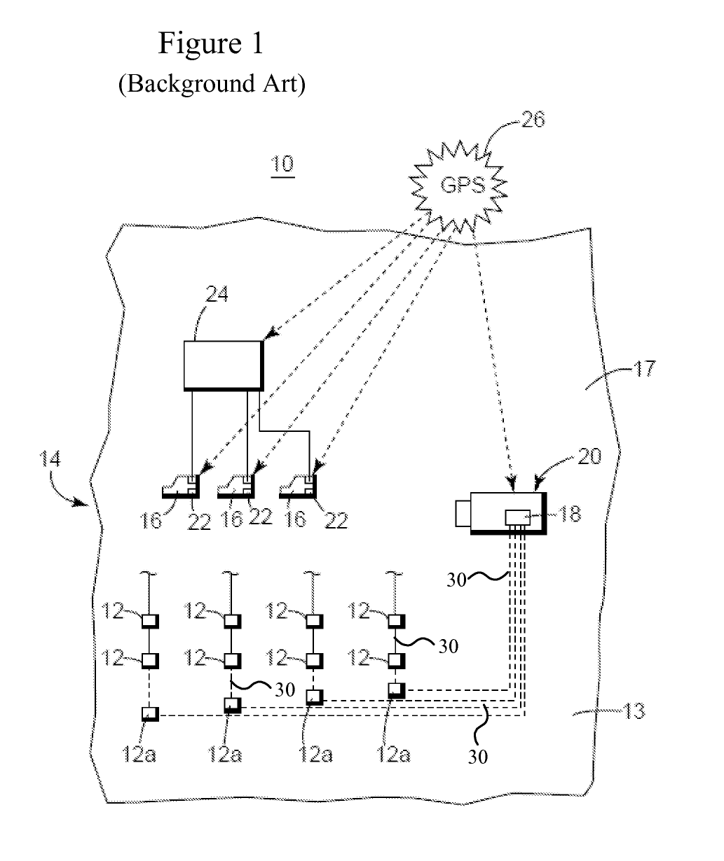

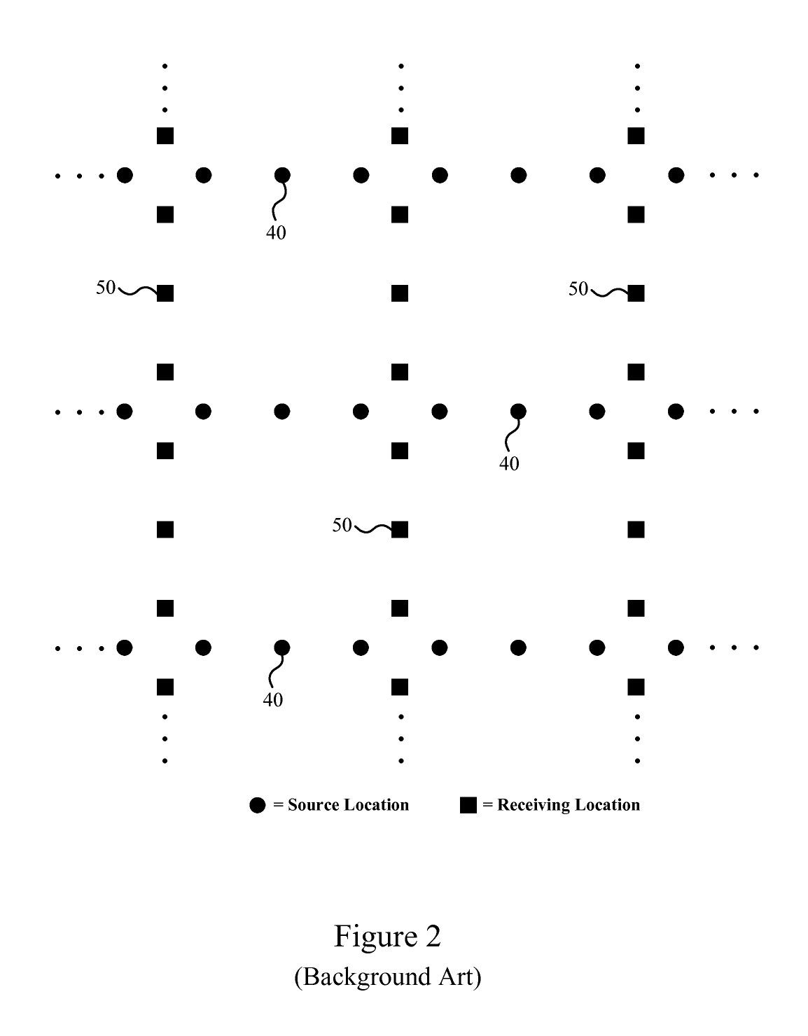

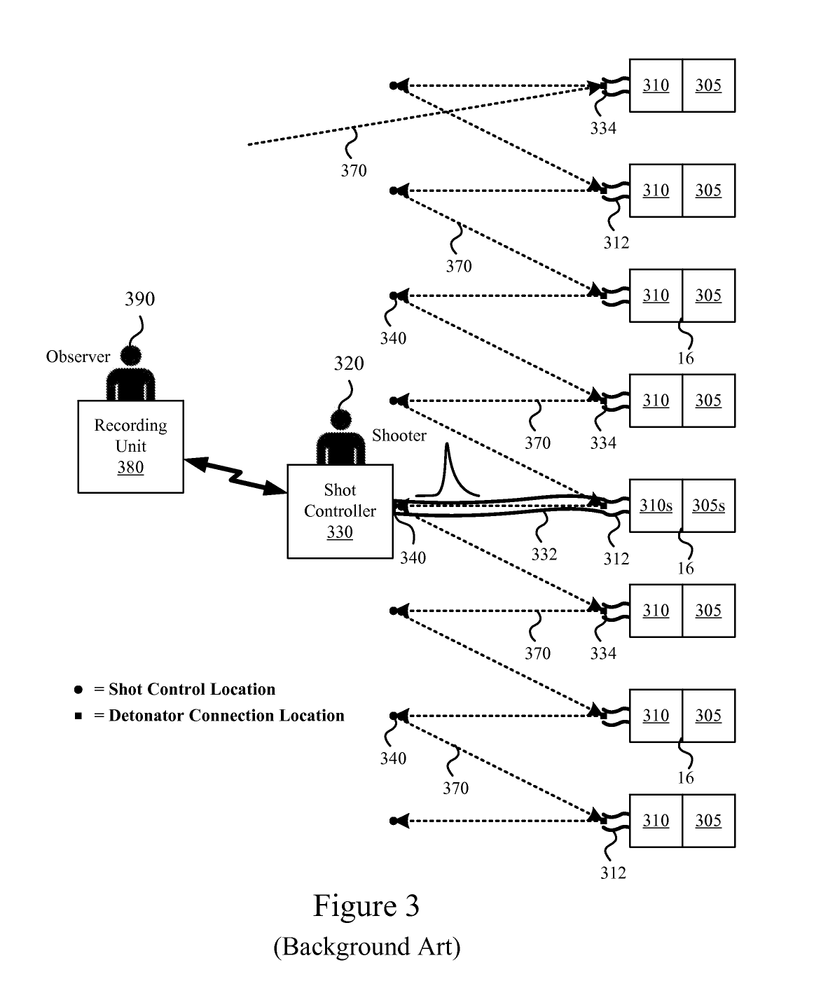

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures, or characteristics may be combined in any suitable manner in one or more embodiments.

U.S. Pat. No. 8,451,686, which is incorporated herein by reference, describes a method for coordinating vibrating sources that are scheduled to follow respective predetermined paths including a succession of shooting positions. A system, apparatus, and method that provide similar benefits for impulsive devices are presented herein.

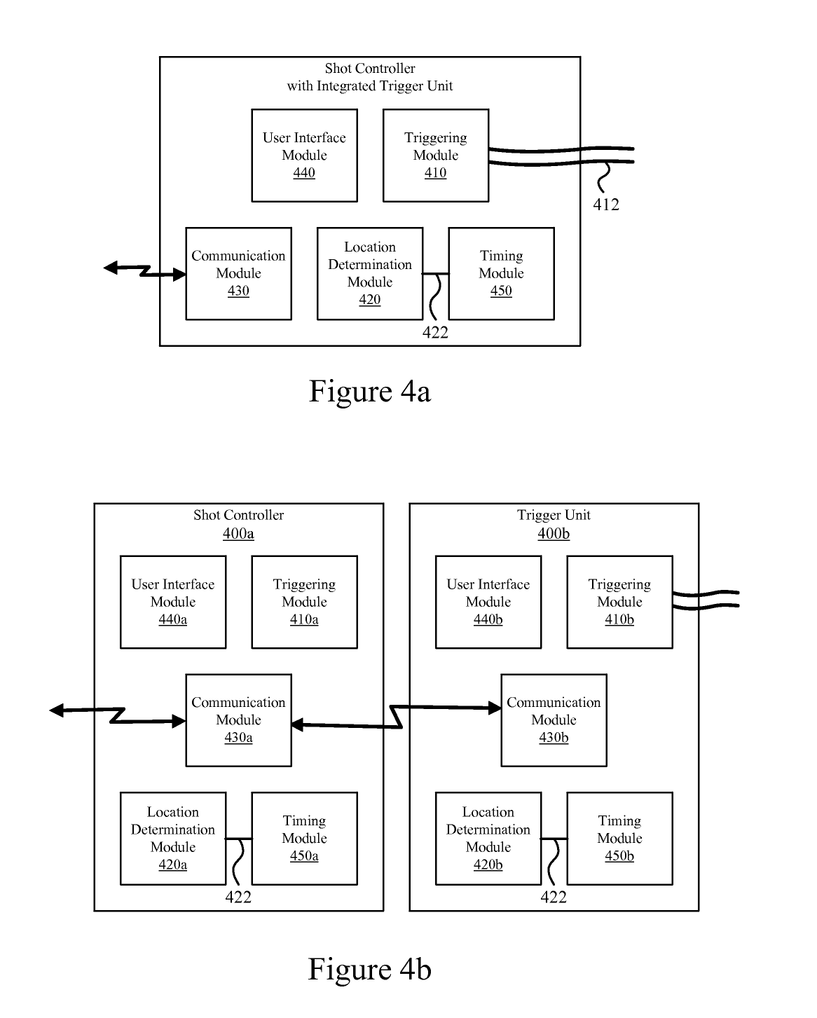

FIG. 4a is a block diagram depicting one embodiment of a shot coordination apparatus 400. As depicted, the shot coordination apparatus 400 includes a triggering module 410, a location determination module 420, a communication module 430, a user interface module 440, and a timing module 450. The shot coordination apparatus 400 enables safe and effective shooting of impulsive sources.

The triggering module 410 interfaces with, and enables triggering of, an impulsive source 16 (not shown in FIG. 4a) via the triggering port 412. The triggering port 412 may be electrically connected to the impulsive source or a detonator for the impulsive source. The triggering module may trigger the impulsive source by outputting a voltage pulse, a digital code, or the like, on the triggering port 412. The precise time of triggering (known as a time-break) may be captured and stored within the memory (not shown) of the apparatus 400 along with other shot information such as the shooting location and ID of the impulsive source 16. The stored information may be communicated to the recording unit 380 and retained within memory to provide backup storage capabilities to the recording unit.

The location determination module 420 estimates, or obtains an estimate of, a current location for the impulsive source connected to the triggering port 412. The current location may be estimated by a variety of means and techniques. For example, the location determination module may include or access movement sensors such as accelerometers that are able to track relative movements from a reference position such as a centralized deployment location for a survey. The location determination module 420 may also include a positioning device that derives an estimate of the current location from multiple electromagnetic signals. For example, the positioning device may be a global positioning device (e.g. GPS, GLONASS, Galileo, and Beidou) that derives an estimate of the current location from multiple electromagnetic signals emitted by satellites. Alternately, the positioning device may derive an estimate of the current location from local electromagnetic signals such as Wi-Fi signals or dedicated positioning signals that are generated to provide positioning information.

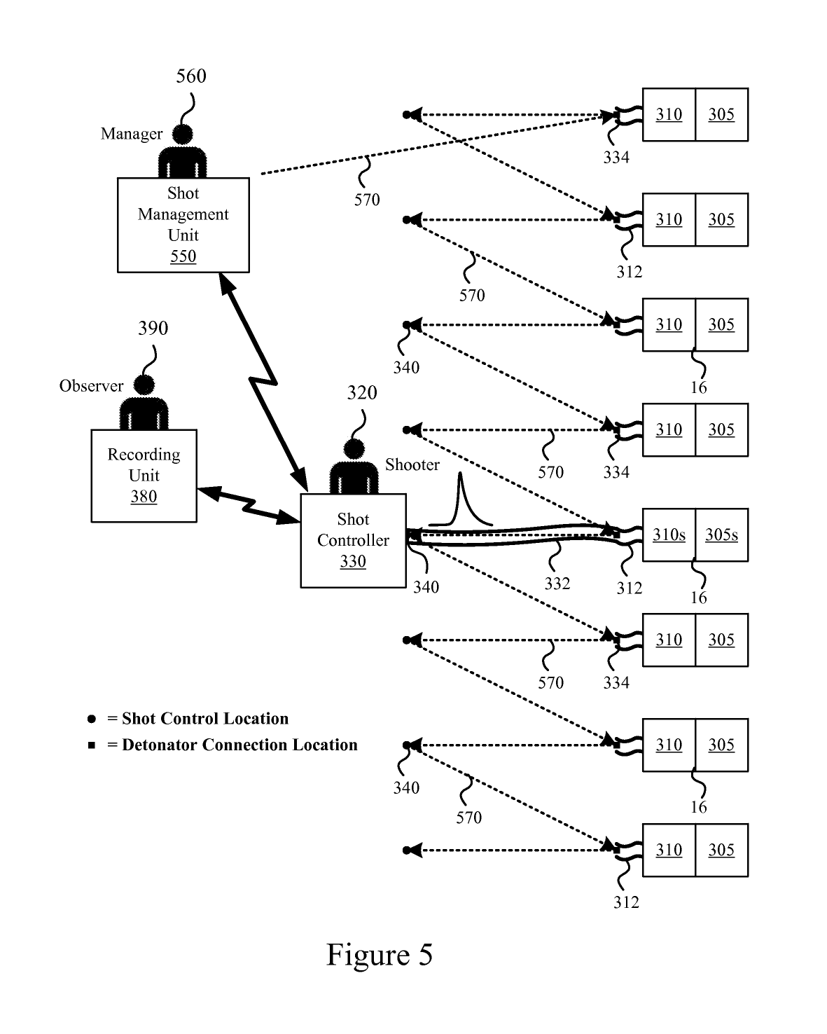

The communication module 430 enables wireless communications with other devices such as a shot management unit 550 (see FIG. 5) and the recording unit 380. For example, updates to the shooting route 370, including intended shot positions, may be received from the shot management unit 550. Similarly, shot information such as source identification codes, executed shot times, and executed shot positions may be transmitted from the device 400 to the recording unit 380.

It should be noted that the communication module 430 is not limited to a particular communication band or technology. For example, the communication module may leverage analog or digital radio signals, cellular signals, and satellite signals, including those supported by Low Earth Orbit (LEO) satellites.

The communication module 430 may support addressable (i.e., routable) communications that enable various devices to send messages to each other without being directly connected to each other. For example, the communication module 430 may support one or more layers of the OSI model including the network (i.e. packet addressing) layer. Supporting addressable communication enables sharing a single communications channel amongst multiple devices 400 and other devices.

The user interface module 440 may enable a user, such as a shooter, to function effectively, and safely, during a geophysical survey. For example, the user interface module 440 may enable a user to “disarm,” “arm,” and “initiate firing” of an impulsive source. The user interface module 440 may also enable real-time feedback to the operator of shooting plan progress, error conditions, positioning (e.g. GPS) errors, missing shots, and the like. In some embodiments, the user interface is able to display a map that shows the location of executed shot locations and intended shot locations. The user interface module 440 may also enable a user to navigate between shot locations, initiate communications with other members of the survey crew, record notes linked to specific shot locations, provide graphical feedback on data recorded by the receivers 12, or change the order of operations and thereby provide flexibility to address issues such as a faulty detonator, missing detonation leads, or the like.

The timing module 450 provides timing information and control to the apparatus 400. In one embodiment, the timing module 450 may be synchronized with a positioning service (e.g. GPS) timing signal 422 provided by the location determination module 420. Preferably, the timing module 450 is able to continue to provide timing information and control to the apparatus 400 when the positioning service timing signal 422 is unavailable or compromised due to obstruction, interference, or other issues common to positioning services such as GPS.

The triggering module 410 may function cooperatively with the other modules of the apparatus 400 to provide a high level of utility to a geophysical survey. For example, the triggering module 410 may inhibit detonation of the impulsive source if the estimated current location of the impulsive source provided by the location determination module 420 is substantially different from an intended shot location. The triggering module 410 may be responsive to a “suspend shooting” command received by the communication module 430 and inhibit the triggering of impulsive sources. The “suspend shooting” command may be sent by the survey manager, the survey recorder, or another member of a survey field crew.

The triggering module 410 may also acknowledge reception of, and compliance with, the “suspend shooting” command by transmitting a “shooting suspended” message to the device that transmitted the “suspend shooting” command and/or another device such as the shot management unit 550 or the recording unit 380. Providing an automated shooting suspension feature in the manner described herein to each apparatus 400 involved in a survey provides a survey-wide safety mechanism that does not require each shooter to properly process human-to-human communications in a timely manner.

In some embodiments, the modules of the shot coordination apparatus 400 are partitioned into a shot controller 400a and a trigger unit 400b as shown in FIG. 4b. The partitioned modules for the shot controller 400a are shown with a numeric reference identifier that is appended with the letter “a,” while the partitioned modules for the trigger unit 400b are shown with a numeric reference identifier that is appended with the letter “b.” One of skill in the art will appreciate that the modules of the shot coordination apparatus 400 may be partitioned into the shot controller 400a and the trigger unit 400b in a variety of configurations that may be application dependent. The partitioned modules may communicate via the communications modules 430a and 430b in order to function seamlessly across the two devices.

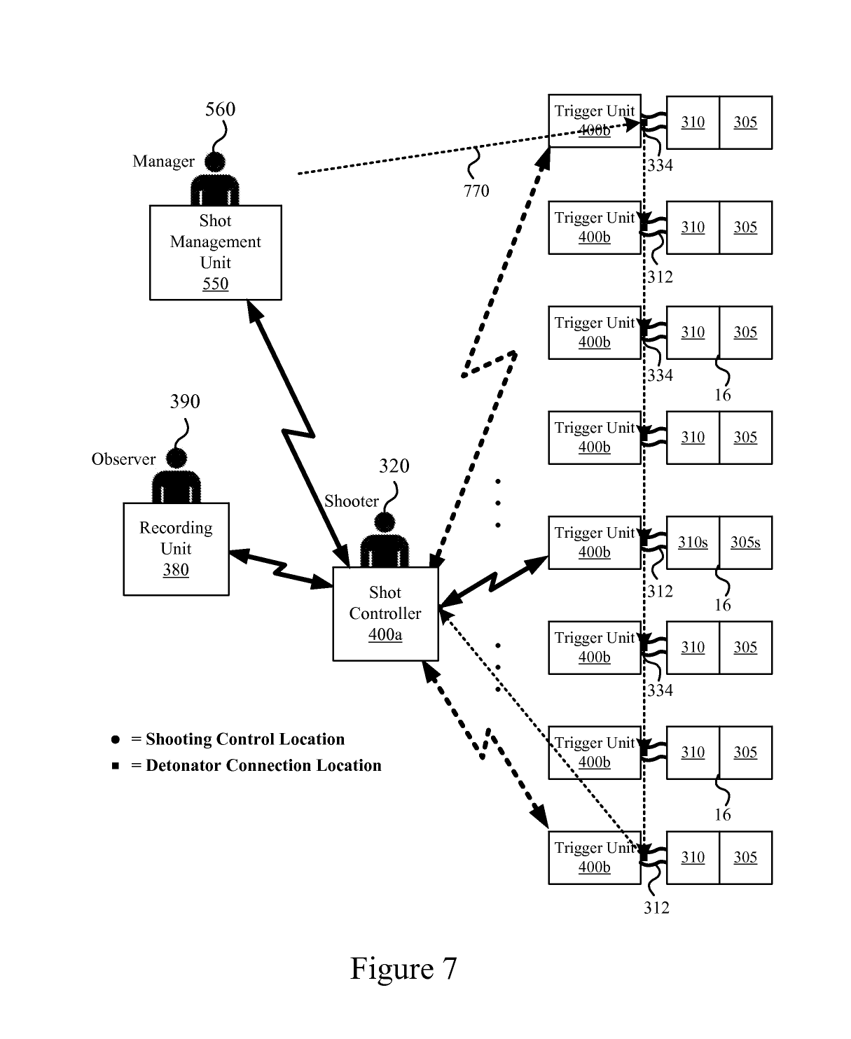

Partitioning the modules of the shot coordination apparatus 400 into a shot controller 400a and a trigger unit 400b may enable additional levels of functionality that are not attainable when the shot controller and trigger unit are integrated into the same device. For example, as will be shown in FIG. 7, a single shot controller 400a may be able to communicate with multiple trigger units 400b and enable a shooter to activate multiple sources 16 from a single shooting location, and thereby increase the achievable shooting rate for a survey.

It should be noted that the modules of the shot coordination apparatus 400 may be partitioned in a manner that meets particular objectives. For example, the modules may be partitioned to minimize overall cost by minimizing the functionality and cost of the triggering units. In such a scenario, the triggering units may not include a positioning device for estimating the current location. Alternately (but not necessarily incompatibly), the modules may be partitioned to maximize the accuracy of location estimates for the impulsive sources. In such a scenario, each triggering unit may have a highly robust and accurate positioning device. The modules may also be partitioned such that one or more of the modules resides entirely, or nearly entirely, on one of the devices 400a or 400b. For example, in some embodiments, the user interface module 440 may reside entirely on the shot controller 400a (as module 440a) and be absent from the trigger unit 400b, while in other embodiments, each device may have a user interface module 440.

FIG. 5 is a block diagram of a planned shot coordination system 500. As depicted, the planned shot coordination system 500 includes many of the same elements as, and is backward compatible with, the shot coordination system 300. Those elements include sources 16 that comprise an explosive charge 305 and a detonator 310, and the recording unit 380. Furthermore, the shot coordination system 500 includes personnel and roles that in many respects are essentially the same as the personnel and roles of the shot coordination system 300, including one or more shooters 320, and an observer 390.

In contrast to the shot coordination system 300, the shot coordination system 500 includes a shot management unit 550 that may be managed by a survey manager 560. The shooting times and locations for the shooters 320 may be advantageously predetermined and assigned by software executing on the shot management unit 550. The survey manager 560 may administer the shot management unit 550 and provide each shooter with a shooting plan (not shown) for the survey. The shooting plan may include a shooting route 570 for each shooter that includes the detonator connection locations 334 and the intended shooting times or timeslots for the shooter (or equipment allocated to the shooter). In addition to advancing to the detonator connection locations 334, each shooter may retreat a safe distance from their assigned sources 16 to a shooting control location 340 resulting in a shooting route 570. To prevent overlapping shots, activation of each source 16 may be manually or automatically deferred until one of any of the assigned predetermined timeslots associated with the shooter is reached.

In some embodiments, the devices of the system 500 may eliminate timing misalignments by synchronizing to a common timing reference such as a reference clock on the recording unit 380. In other embodiments, timing misalignments are eliminated by sending messages to each other with timing information embedded therein, capturing the transmission time and reception time of such messages, and determining a timing skew from the timing information. One of skill in the art will appreciate that following such a procedure enables peer-to-peer timing synchronization.

The system 500 also enables partial or complete autonomous operation for each shooter 320 in that shooting may continue during intervals where communications to the recording unit 380 or the shot management unit 550 are inhibited or compromised. Upon completion of each shooting route 570, the shooters may return to the recording unit 380 or the shot management unit 550 and upload any data which was not uploaded during the survey.

Furthermore, the system 500 enables a survey manager 560 to reserve predetermined shooting times and/or locations in order to provide additional flexibility to a survey. For example, a survey manager may initially deploy a large number of shooters without allocating all of the shooting locations to a shooter. Subsequently, the survey manager may assign shooters that have completed their assignments to previously unassigned shooting locations. Similarly, the allocation of predetermined shooting times may be managed so that additional shooters may be added to an area without changing the previously assigned shooting locations and shooting times.

In a further refinement, the survey manager 560 can dynamically update the shooting locations and predetermined shooting times among shooters in communication range. For example, shooters may be added to mitigate slower shooting rates in areas of rough terrain.

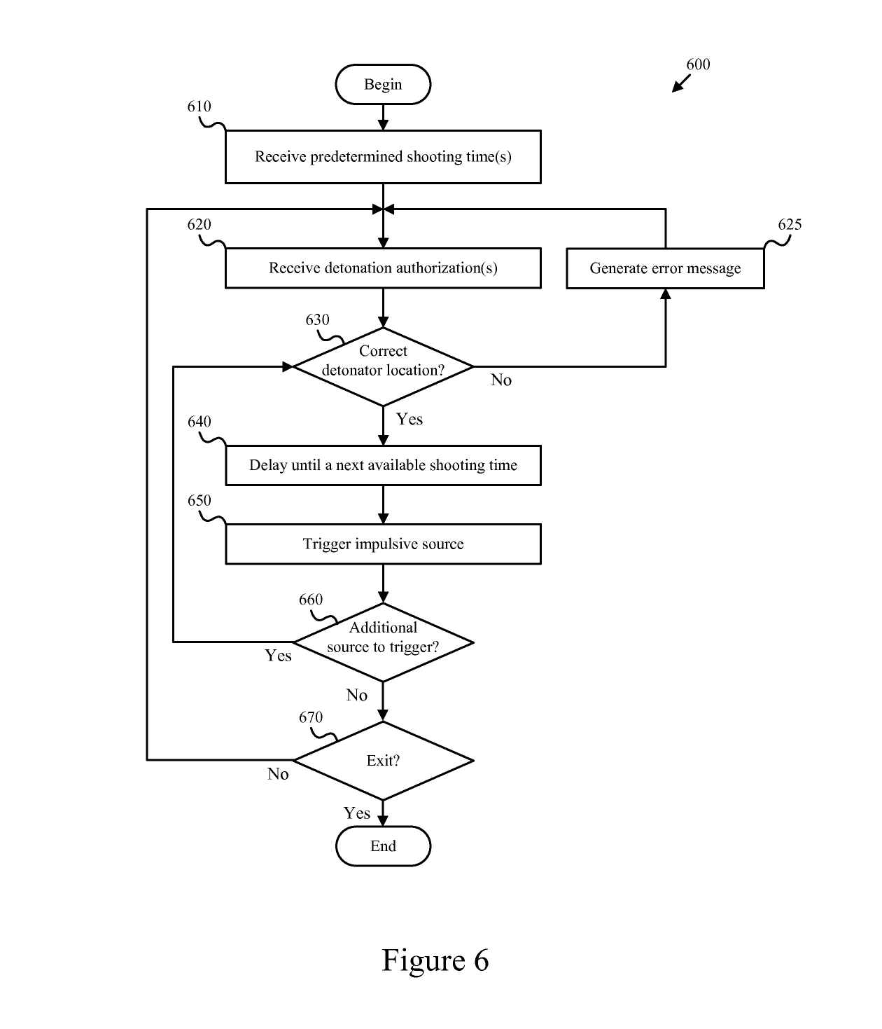

FIG. 6 is flowchart diagram depicting one embodiment of a shot coordination method 600. As depicted, the shot coordination method 600 includes receiving 610 one or more predetermined shooting times, receiving 620 one or more detonation authorizations, determining 630 if a detonator is at a correct location, delaying 640 until a next available shooting time, triggering 650 an impulsive source, determining 660 if an additional source is to be triggered, and determining 670 if the method is to be terminated. The shot coordination method may be conducted by the shot coordination apparatus 400 with an integrated trigger unit or the apparatus 400 partitioned into the shot controller 400a and trigger unit 400b.

Receiving 610 one or more predetermined shooting times may include receiving a set of allocated shooting times, receiving a formula for determining an authorized shooting time, or the like. The predetermined shooting times may be specific instances of time or time intervals (i.e., time slots) over which a shot may be fired. The predetermined shooting times may, or may not be, location or area dependent. Preferably, multiple predetermined shooting times are available for each location or area in order to provide flexibility to a shooter, and operational robustness to a field crew.

The predetermined shooting times may be allocated by the shot management unit 550 and reserved for a specific device such as a specific shot controller 400a or a specific triggering unit 400b. For example, the predetermined shooting times may be programmed into a specific device previous to deployment. The predetermined shooting times may also be allocated for a specific role or person, such as a specific shooter 320. For example, in one embodiment a shooter may login to an arbitrary shot controller 400 or 400a previous to conducting a survey and in response thereto, the arbitrary shot controller 400 or 400a may retrieve the predetermined shooting times from the shot management unit 550.

Receiving 620 one or more detonation authorizations (e.g., messages) may include receiving authorization from the survey manager via the shot management unit 350. The authorization may be received by the shooting coordination apparatus 400 or the shot controller 400a. In one embodiment, detonation of each impulsive source must be individually authorized. In other embodiments, detonation of a set of sources such as all sources assigned to a particular shooter or all sources within a specific area may be authorized as a group. Subsequently, the authorization may be forwarded, approved, confirmed, acted upon, or activated by the shooter 320 via the user interface module 440 on the shooting coordination apparatus 400 or the user interface module 440a on the shot controller 400a. In some embodiments, one or more detonation authorizations may be suspended or revoked via a “suspend shooting” command or the like transmitted by a member of the survey crew.

Determining 630 if a detonator is at a correct location may include estimating a current location for the triggering unit 400b, the source 16, the detonator 310, or the explosive charge 305. Determining 630 may also include determining if the estimated current location corresponds to an intended location for a shot. Determining 630 may also include determining if an identifier for a source 16 that is currently connected to the integrated or stand-alone triggering unit matches an identifier for a source 16 that was previously placed at the intended location by a field crew.

Delaying 640 until a next available shooting time may include determining the next available shooting time from the predetermined shooting times, and waiting for an electronic clock, or other source of timing, to advance to the predetermined shooting time. In one embodiment, the delay operation 640 is accomplished by delaying transmission of a detonation authorization to a triggering unit 400b from a shot controller 400a. Similarly, the delay operation 640 may be accomplished by delaying transmission of a detonation signal, message, or authorization to a detonator 310 from a triggering unit 400b. In another embodiment, a detonation authorization sent to a shot controller 400, a shot controller 400a, or a triggering unit 400b includes the next available shooting time and the receiving device executes the delaying operation 640.

Triggering 650 an impulsive source may include sending an electronic signal, such as a pulse or an electronic code, to the selected detonator 310s. Determining 660 if an additional source is to be triggered may include referencing the list of detonation authorizations received in step 620 to determine if all of the authorizations have been acted upon.

Determining 670 if the method is to be terminated may include determining if a “suspend shooting” command has been received by the communication module 430 or the shooter has set a power switch for the partitioned or unpartitioned device 400 in an “off” position.

FIG. 7 is a block diagram of a shot coordination system 700. As depicted, the shot coordination system 700 includes many of the same elements as, and is backward compatible with, the survey shot coordination system 300 and the planned shot coordination system 500. Those elements include sources 16 that comprise an explosive charge 305 and a detonator 310, the shot management unit 550, and the recording unit 380. Furthermore, the shot coordination system 700 includes personnel and roles that in many respects are essentially the same as the personnel and roles of the shot coordination system 500, including one or more shooters 320, a survey manager 560, and an observer 390.

In contrast to the shot coordination system 300 and the planned shot coordination system 500, the expedited shot coordination system 700 improves the achievable shooting rate for the shooters 320 by providing multiple trigger units 400b that can be placed proximate to, and connected with, the detonators 310. Providing multiple trigger units 400b, enables the shooter to activate multiple explosive charges 305 from a single control location. Additionally, the shooter 320 is no longer required to repeatedly advance to, and retreat from, each source 16 resulting in a shooting route 770 that is shorter than the shooting route 370.

One of skill in the art will appreciate that the shot coordination system 700 provides a number of additional advantages over the shot coordination system 300. For example, the location, detonation time, and uphole characteristics of the source 16 may be determined by a trigger unit 400b that is highly proximate to the source 16. Furthermore, the shot controller 400a operated by the shooter may support advanced positioning (e.g. GPS) services, provide a high level of user control, and support communications to the recording unit 380 without requiring support for these features by the trigger unit 400b. Furthermore, in some embodiments the ability to supporting addressable communications with the communications module(s) 430 provides additional robustness to the system 700. For example, supporting addressable communications may enable a single shot controller 400a to communicate with, and control, multiple trigger units 400b without being directly connected to each trigger unit 400b.

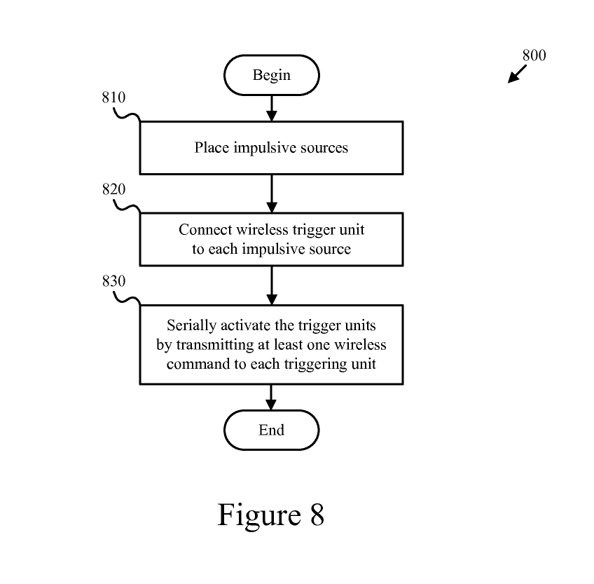

FIG. 8 is flowchart diagram depicting one embodiment of a shot coordination method 800 for a field crew. As depicted, the shot coordination method 800 includes placing 810 a number of impulsive sources, connecting 820 a trigger unit to each impulsive source, and serially activating 830 the trigger units. The shot coordination method 800 may be conducted by one or more members of a field crew in conjunction with the shot coordination system 700, or the like.

Placing 810 a number of impulsive sources may include placing a source 16 at each intended location. In some embodiments, a hole is bored into the earth at each intended location and a source 16 is placed at a desired depth below the surface.

Connecting 820 a triggering unit to each impulsive source may include placing a trigger unit 400b proximate to each impulsive source and connecting the trigger unit 400b to the corresponding impulsive source. For example, wire leads for a detonator of the impulsive source may be connected to the trigger unit 400b.

Serially activating 830 the trigger units may include using the shot controller 400a to wirelessly communicate with each trigger unit and initiate a detonation sequence for the impulsive source. The detonation sequence may include waiting for a next available shooting time as detailed in the description of the shot coordination method 600 and elsewhere herein.

In summary, the shot coordination methods, apparatuses, and systems presented herein provide a number of distinct advantages over prior art shot coordination methods, apparatuses, and systems.

It should be noted that some of the functional units described herein are explicitly labeled as modules while others are assumed to be modules. One of skill in the art will appreciate that the various modules described herein may include a variety of hardware components that provide the described functionality including one or more processors such as CPUs or microcontrollers that are configured by one or more software components. The software components may include executable instructions or codes and corresponding data that are stored in a storage medium such as a non-volatile memory, or the like. The instructions or codes may include machine codes that are configured to be executed directly by the processor. Alternatively, the instructions or codes may be configured to be executed by an interpreter, or the like, that translates the instructions or codes to machine codes that are executed by the processor.

It should also be understood that this description is not intended to limit the invention. On the contrary, the exemplary embodiments are intended to cover alternatives, modifications, and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for controlling impulsive sources during a geophysical survey, the method comprising:
receiving a plurality of predetermined shooting times for an impulsive source;
receiving a detonation authorization for the impulsive source; and
delaying a triggering of the impulsive source until a next available shooting time of the plurality of predetermined shooting times.

2. The method of claim 1, further comprising allocating the plurality of predetermined shooting times.

3. The method of claim 1, wherein the plurality of predetermined shooting times are reserved for a shot controller.

4. The method of claim 3, wherein the plurality of predetermined shooting times are programmed into the shot controller.

5. The method of claim 1, wherein the plurality of predetermined shooting times are programmed into a triggering unit.

6. The method of claim 1, wherein the plurality of predetermined shooting times are time slots.

7. The method of claim 1, wherein triggering of the impulsive source is delayed by delaying transmission of the detonation authorization to a triggering unit.

8. The method of claim 1, wherein triggering of the impulsive source is delayed by a triggering unit connected to the impulsive source.

9. The method of claim 1, wherein the detonation authorization includes the next available shooting time.

10. An apparatus for controlling impulsive sources during a geophysical survey, the apparatus comprising:
a triggering module configured to interface to and trigger an impulsive source; and
the triggering module further configured to receive a plurality of predetermined shooting times and delay a triggering of the impulsive source until a next available shooting time of the plurality of predetermined shooting times.

11. The apparatus of claim 10, wherein the triggering module is partitioned onto a shot controller and a triggering unit.

12. The apparatus of claim 11, wherein the shot controller and the trigger unit communicate via a wireless channel.

13. The apparatus of claim 10, further comprising a user interface module configured to enable a user to arm the impulsive source.

14. The apparatus of claim 10, wherein the triggering module is responsive to a “suspend shooting” command received by a communication module.

15. The apparatus of claim 10, further comprising a location determination module configured to estimate a current location for the impulsive source.

16. The apparatus of claim 15, wherein the triggering module is configured to inhibit triggering of the impulsive source if the current location does not substantially correspond to an intended location.

17. A system for controlling impulsive sources during a geophysical survey, the system comprising:
a plurality of triggering units;
a shot controller configured to transmit a detonation authorization to a selected triggering unit of the plurality of triggering units; and
wherein the shot controller or the selected triggering unit is configured to delay a triggering of an impulsive source connected to the selected triggering unit until a next available shooting time of a plurality of predetermined shooting times.

18. The system of claim 17, further comprising a recording unit for recording detonation events.

19. The system of claim 17, further comprising a shot management unit.

20. The system of claim 19, wherein the shot management unit communicates the plurality of predetermined shooting times to the shot controller.
